(19) United States
(12) Patent Application Publication
(10) Pub. No.: US 2010/0050378 A1
(43) Pub. Date: Mar. 4, 2010

(54) TILTED UP HANDLE

(76) Inventor: MATTHEW FRANK, Seattle, WA (US)

Correspondence Address: Karr Tuttle Campbell;ATTN: PRIYA SINHA CLOUTIER, 1201 Third Ave., Ste 2900, Seattle, WA, 98101, US

(21) Appl. No.: 12/618,525

(22) Filed: Nov. 13, 2009

Related U.S. Application Data
(63) Continuation-in-part of application No. 12/037,668, filed on Feb. 26, 2008.

(51) Int. Cl. B25G 1/00

(52) U.S. Cl. 16/110.1

(57) ABSTRACT

The instant invention provides a stable, ergonomic handle that can be used with any type of kitchen utensil or other tool.

### CROSS-REFERENCES TO RELATED APPLICATIONS

This application is a continuation-in-part of pending U.S. patent application Ser. No. 12/037668 filed on 26 Feb. 2008.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### FIELD OF INVENTION

The present invention relates to a handle. Specifically, the present invention relates to a handle for a kitchen utensil which prevents a kitchen utensil from touching a counter top or other horizontal surface.

### BACKGROUND

Food safety is a great concern. Every year, hundred of people fall ill because their food has been exposed to bacteria or virus. During the cooking process spoons, tongs, spatulas and such are often placed on a counter top.

If a counter top has not been cleaned, contaminants can be transferred to food. For example, a cook may place a spoon on a countertop and without cleaning the spoon, place it into a soup he is stirring. In another example, a person scoops ice cream from a container, places the ice cream scoop on a countertop and, then licks of the off the excess ice cream from the ice cream scoop. In this scenario, the contaminate immediately enters the person's body. Additionally, the counter has become soiled.

The purpose of the instant invention is to provide a stable, ergonomic handle that can be used with any type of kitchen utensil.

### BRIEF SUMMARY OF THE INVENTION

A stable, ergonomic handle that can be used with any type of kitchen utensil.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an front elevation view of the present invention;

FIG. 2 is a front view of the present invention;

FIG. 3 is a side elevation view of the present invention;

FIG. 4 is a bottom view of the present invention;

FIG. 5 is a back view of the present invention;

FIG. 6 is a top view of the present invention.

### DETAILED DESCRIPTION OF THE INVENTION

The present invention, an ergonomic, stable handle (“Handle”), is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete and will fully convey the scope of the invention to those skilled in the art.

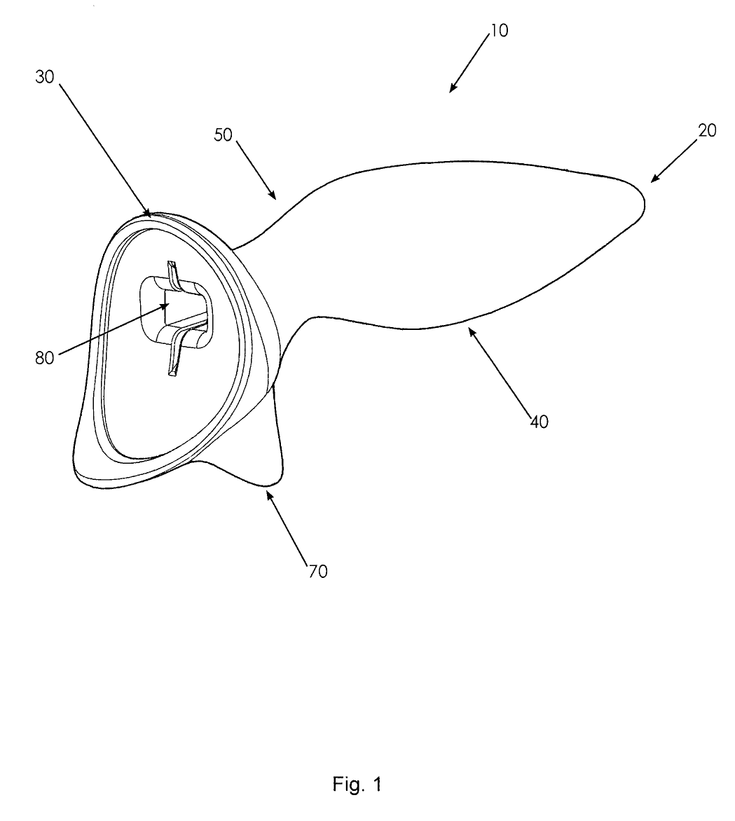

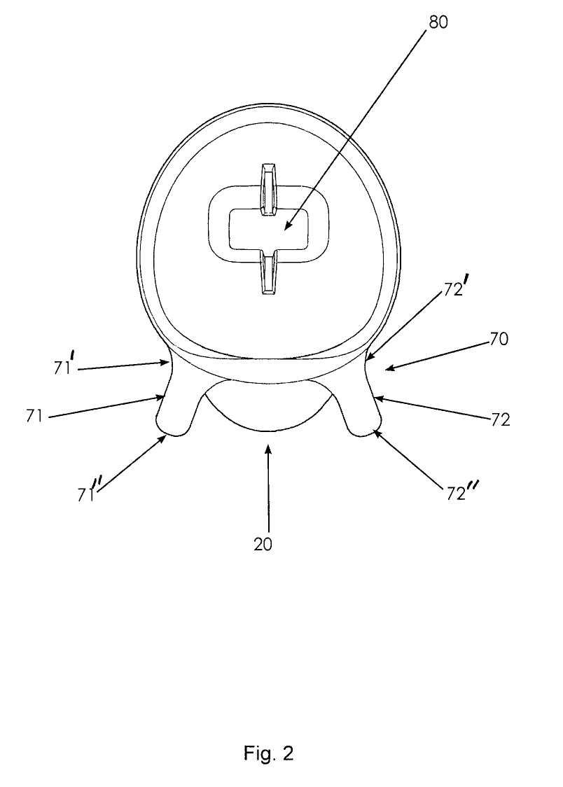

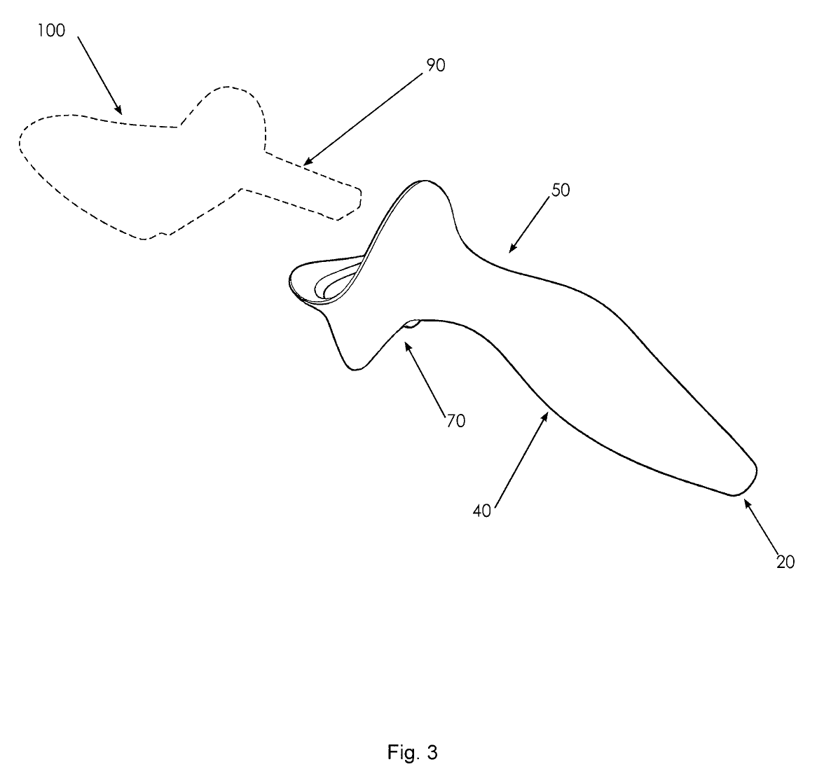

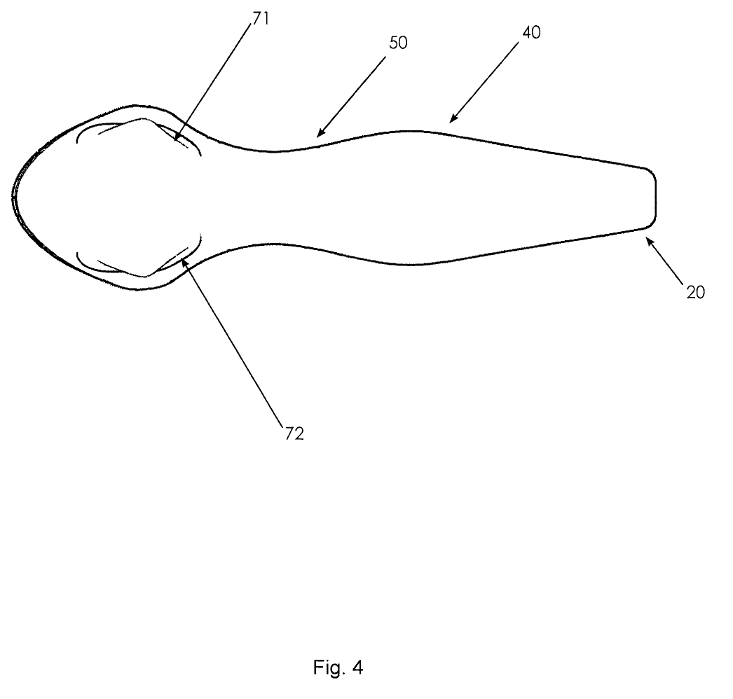

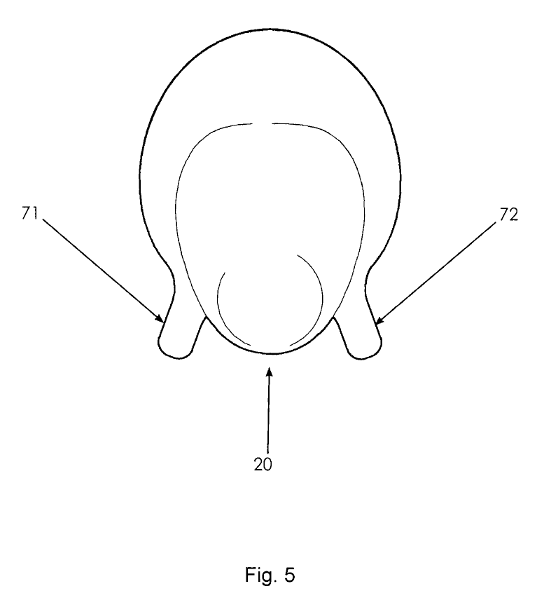

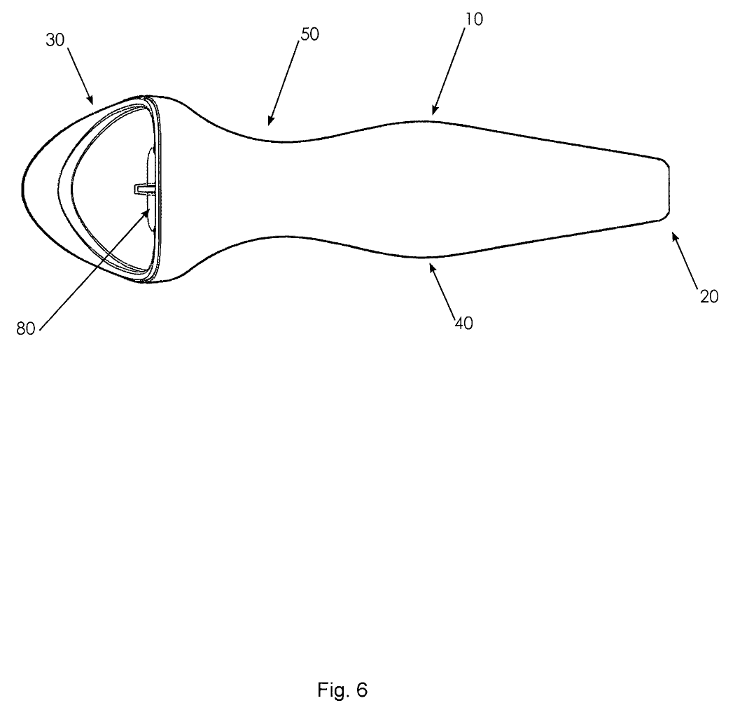

For exemplary purposes, the Handle (10) is shown as part of an ice cream scoop. However, it will be obvious to a person of ordinary skill in the art that the handle can be attached to any type of kitchen utensil or other types of tools. The following descriptions refer generally to FIGS. 1 through 6.

The handle (10) is generally cylindrical shaped having a first end (20), a second end (30), and a middle portion (40) disposed therebetween. The middle portion (40) having a circumference greater than the circumference of the first end (20). The circumference of the middle portion (40) gradually decreases toward the first end (20).

The circumference of the middle portion (40) gradually decreases towards the second end (30) to a locus (50), and then flares out to a circumference sufficient in size to so that a Handle (10) can effectively support a kitchen utensil.

The second end (30) comprises a support (70). When placed on a horizontal surface, the second end (30) is elevated above the horizontal surface and the first end touches the horizontal surface.

The second end (30) defines a means to attach a kitchen utensil (80) to the Handle (10). In the preferred embodiment, the means to attach (80) is of sufficient size to accept a tongue (90) from the kitchen utensil (100). The kitchen utensil (100) can be permanently attached. However, the kitchen utensil (100) can be removably attached.

The support (70) comprises at least a first arm (71) and a second arm (72). The first arm (71) has a first attached end (71′)and a first free end (71″); said first attached end (71′) is attached to the Handle (10). The second arm (72) has a second attached end (72′) an a second free end (72″); said second attached end (71′) is attached to the Handle (10). The distance between the first free end (71″) and the second free end (72″) is greater than the distance between the first attached end (71′) and the second attached end (72′).

What is claimed is:

1. A handle comprising a first end, a second end, and a middles portion; said middle portion is disposed between the first end and the second end.

2. The handle of claim 1 has a cylinder shape.

3. The handle of claim 2 such that the middle portion has a circumference greater than the circumference of the first end.

4. The handle of claim 3 such that the circumference of the middle portion gradually decreases toward the first end.

5. The handle of claim 4 such that the circumference of the middle portion gradually decreases towards the second end to a locus, and then flares out to a larger circumference.

6. The handle of claim 5 such that the second end comprises a support.

7. The handle of claim 6, when placed on the horizontal surface, the second end is elevated above the horizontal surface and the first end touches the horizontal surface.

8. The support of claim 6 comprises at least a first arm and a second arm.

9. The first arm of claim 8 has a first attached end and a first free end; said first attached end is attached to the handle.

10. The second arm of claim 8 comprises a second attached end and a second free end; said second attached end is attached to the handle.

11. The support of claim 8 such that the distance between the first free end and the second free end is greater than the distance between the first attached end and the second attached end.

12. The handle of claim 11 such that the second end defines a means to secures a kitchen utensil or other tool the handle.
